(19) United States
(12) Patent Application Publication
(10) Pub. No.: US 2020/0168033 A1
(43) Pub. Date: May 28, 2020

(54) COMPUTER SYSTEM AND A COMPUTER IMPLEMENTED METHOD FOR PROCESSING GAMING DATA

(71) Applicant: GEO-PRO-TEQ IP PTY LTD, Woolloomooloo, New South Wales (AU)

(72) Inventors: Jason MCQUEEN, Woolloomooloo, New South Wales (AU); Lars KLANDER, Woolloomooloo, New South Wales (AU); Bryan TE WANI, Woolloomooloo, New South Wales (AU)

(21) Appl. No.: 16/614,040

(22) PCT Filed: Mar. 29, 2018
(86) PCT No.: PCT/AU2018/050296

§ 371 Date: Nov. 15, 2019

(30) Foreign Application Priority Data
Mar. 31, 2017 (AU) 2017901191

(51) Int. Cl. G07F 17/32

(52) U.S. Cl. CPC G07F 17/3225; G07F 17/3218; G07F 17/326; G07F 17/3223

(57) ABSTRACT

A computer system for processing gaming data from two or more gaming systems includes a memory device configured to store machine-readable instructions and a processor connected to the memory device. Various communication interfaces process gaming data. The processor obtains the machine-readable instructions and receives first gaming based on a first protocol, and second gaming data based on a second protocol that is different from the first protocol. The processor determines identity information associated with a user and first usage information associated with use of the first gaming system by the user, and determines from the second gaming data and based on the second protocol, the identity information associated with the user and second usage information associated with use of the second gaming system by the user. The processor sends the identity information, the first usage information and the second usage information to the first server.

### FIELD OF THE INVENTION

The present invention relates to gaming systems and in particular to processing of gaming data and controlling access of a user to a gaming system.

### BACKGROUND OF THE INVENTION

Harm minimization in gaming industry has become a topic of discussion due to the conception of gaming being an addiction. There have been a number of solutions suggested for implementing harm minimization in gaming. Some of such solutions include removal of ATMs, pre-commitment, reduction in maximum bets, self-eviction, signage, message on gaming machines and identification of people with gambling problems and interaction with gamblers etc.

However, the greatest challenge lies in developing systems and methods which are able to read trends in behaviours of a gambler, identify potential problem issues and suggest and even facilitate implementation of harm minimization techniques.

Any discussion of the background art throughout the specification should in no way be considered as an admission that such background art is prior art nor that such background art is widely known or forms part of the common general knowledge in the field in Australia or worldwide.

All references, including any patents or patent applications, cited in this specification are hereby incorporated by reference. No admission is made that any reference constitutes prior art. The discussion of the references states what their authors assert, and the applicants resere the right to challenge the accuracy and pertinence of the cited documents. It will be clearly understood that although a number of prior art publications are referred to herein, this reference does not constitute an admission that any of these documents forms part of the common general knowledge in the art, in Australia or in any other country.

### SUMMARY OF THE INVENTION

According to a first aspect of the present invention, there is provided a computer system for processing gaming data from two or more gaming systems, the computer system comprising a memory device configured to store machine-readable instructions, a processor connected to the memory device and a first communication interface connected to the processor and configured to connect to a first gaming system and a second communication interface connected to the processor and configured to connect to a second gaming system that is different from the first gaming system, a third communication interface connected to the processor and configured to connect to a first sewer, wherein the processor obtains the machine-readable instructions from the memory device and is configured by the machine-readable instructions to receive, via the first communication interface, first gaming data from the first gaming system, the first gaming data being generated by the first gaming system based on a first protocol, receive, via the second communication interface, second gaming data from the second gaming system, the second gaming data being generated by the second gaming system based on a second protocol that is different from the first protocol, determine, from the first gaming data and based on the first protocol, identity information associated with a user and first usage information associated with use of the first gaming system by the user, determine, from the second gaming data and based on the second protocol, the identity information associated with the user and second usage information associated with use of the second gaming system by the user and send the identity information, the first usage information and the second usage information to the first sewer via the third communication interface. This way the usage information and the identity information can be obtained from a variety of gaming systems that adopt different gaming protocols.

In one embodiment of the invention, the processor is further configured to receive an instruction from the first sewer and in response to the instruction, cause the first gaming system or the second gaming system not to be used by the user for gaming.

In one embodiment of the invention, the computer system further comprises a computing device configured to generate a first digital signature and a first timestamp associated with the first gaming data and send the first digital signature and the first timestamp to the first server. In one embodiment of the invention, the computing device is further configured to generate a second digital signature and a second timestamp associated with the second gaming data and send the second digital signature and the second timestamp to the first server.

According to a second aspect of the present invention, there is provided a computer system for controlling access of a user to a gaming system, the computer system comprising a memory device configured to store machine-readable instructions, a processor connected to the memory device, a first communication interface connected to the processor and configured to connect to a first further computer system as introduced in the first aspect, the first further computer system being connected to the gaming system, a second communication interface connected to the processor and configured to connect to a second further computer system, the second further computer system being configured to interact with the user, wherein the processor obtains the machine-readable instructions from the memory device and is configured by the machine-readable instructions to receive, via the second communication interface, an indication indicative of an interaction of the user with the second further computer system, generate an instruction based on the indication, send, via the first communication interface, the instruction to the first further computer system for the first further computer system to control the access of the user to the gaming system based on the instruction.

In one embodiment of the invention, the indication indicates that the user does not want to use the gaming system, and the instruction causes the first further computer system to disable the gaming system.

In one embodiment of the invention, the computer system further comprises a third communication interface configured to connect to a third further computer system.

In one embodiment of the invention, the processor is further configured to receive, from the first further computer system via the first communication interface, identity information associated with the user, usage information of the gaming system associated with use of the gaming system by the user, determine a unique identification that represents the identity information associated with the user based on the identity information and send, via the third communication interface, the unique identification and the usage information to the third further computer system.

In one embodiment of the invention, the processor is further configured to receive via the third communication interface from the third further computer system a further indication indicating that the user does not want to use the gaming system, generate a further instruction based on the further indication, and send, via the first communication interface, the further instruction to the first further computer system for the first further computer system to disable use of the gaming system by the user.

In one embodiment of the invention, the computer system further comprises a computing device configured to generate a digital signature and a timestamp associated with the unique identification and the usage information and send the digital signature and the timestamp to the third further computer system.

In one embodiment of the invention, the processor is configured to determine the unique identification by performing a hash operation on the identity information.

In one embodiment of the invention, the processor is configured to determine the unique identification by generating a public key and a private key based on the identity information and determining the unique identification based on the public key.

According to a third aspect of the present invention, there is provided a computer system for controlling access of a user to a gaming system, the computer system comprises a memory device configured to store machine-readable instructions, a processor connected to the memory device, a communication interface connected to the processor and configured to connect to a further computer system as introduced in the second aspect and a user interaction system connected to the processor to interact with the user, wherein the processor obtains the machine-readable instructions from the memory device and is configured by the machine-readable instructions to present a user interaction interface on the user interaction system, the user interaction interface including a user interface element indicating that the user does not want to use the gaming system, receive from the user interaction system an indication that the user activates the graphic user interface element and send, via the communication interface, the indication to the further computer system to disable the access of the user to the gaming system.

In one embodiment of the invention, the user interaction system comprises a touch-sensitive screen, the user interaction interface comprises a graphic user interface, and the user interface element comprises a graphic button.

In one embodiment of the invention, the computer system further comprises a card reader configured to read identity information from a card used by the user to access the gaming system, the identity information representing identity of the user, wherein the processor is further configured to receive the identity information from the card reader, determine the identity of the user from the identity information, determine the user is not allowed to access the gaming system based on the identity of the user, disable the card so as to disable the access of the user to the gaming system.

In one embodiment of the invention, the computer system further comprises a positioning device configured to determine a current position of the user, wherein the processor is further configured to receive the current position of the user from the positioning device, determine a reference position and if a difference between the current position of the user and the reference position is less than a threshold, disable the card used by the user to disable the access of the user to the gaming system. In one embodiment of the invention, the positioning device comprises three or more beacons configured to determine the current position of the user.

In one embodiment of the invention, the positioning device includes a G lobal Positioning System (GPS) device.

In one embodiment of the invention, the graphic user interface includes a further graphic user interface element indicating that the user intends to use the gaming system, and the processor is further configured to receive from the touch-sensitive screen a further indication that the user activates the further graphic user interface element and send, via the communication interface, the further indication to the further computer system to enable the access of the user to the gaming system.

In one embodiment of the invention, the processor is configured to send the indication to the further computer system to disable the user to game on the gaming system for a certain period of time. This allows the gaming system to be blocked as per a present condition of the user. In this manner, the user may still have privileges to participate in gaming if the certain period of time has elapsed and the user is assumed to be in normal state of mind.

In one embodiment of the invention, the processor is further configured to send a message to a device associated with an assistance provider to alert the assistance provider, the message including the identity information representing identity of the user. In one embodiment of the invention, the assistance provider comprises a psychologist, a caregiver, a social worker, a counsellor, a police officer or an operator of the gaming system.

According to a fourth aspect of the present invention, there is provided a computer system for determining a user is not allowed to access a gaming system, comprising a memory device configured to store machine-readable instructions, a processor connected to the memory device, a communication interface connected to the processor and configured to connect to a further computer system as introduced in the second aspect and wherein the processor obtains the machine-readable instructions from the memory device and is configured by the machine-readable instructions to receive, via the communication interface from the further computer system, an unique identification associated with the user and usage information associated with of use of the gaming system by the user, determine the user is not allowed to access the gaming system based on the unique identification and the usage information and store usage information in association with the unique identification in a database.

In one embodiment of the invention, the processor is configured to determine the user is not allowed to access the gaming system by obtaining past usage information associated with the use of the gaming system by the user from the database based on the unique identification and determining the user is not allowed to access the gaming system based on the usage information and the past usage information.

In one embodiment of the invention, the database comprises a blockchain. In one embodiment of the invention, the processor is further configured to send a computer program to a portable device associated with the user, the computer program causing the portable device to provide a current position of the user.

In one embodiment of the invention, the processor is further configured to receive an indication from the portable device indicating that the user does not want to use the gaming system.

In one embodiment of the invention, the processor is further configured to send, via the communication interface, the indication to the further computer system to disable use of the gaming system by the user.

According to a fifth aspect of the present invention, there is provided a computer implemented method for processing gaming data from two or more gaming systems, the method comprising receiving first gaming data from a first gaming system, the first gaming data being generated by the first gaming system based on a first protocol, receiving second gaming data from a second gaming system, the second gaming data being generated by the second gaming system based on a second protocol that is different from the first protocol, determining, from the first gaming data and based on the first protocol, identity information associated with a user and first usage information associated with use of the first gaming system by the user, determining, from the second gaming data and based on the second protocol, the identity information associated with the user and second usage information associated with use of the second gaming system by the user and sending the identity information, the first usage information and the second usage information to a first server.

In one embodiment of the invention, the method further comprises receiving an instruction from the first server and in response to the instruction, causing the first gaming system or the second gaming system not to be used by the user for gaming.

In one embodiment of the invention, the method further comprises generating a first digital signature and a first timestamp associated with the first gaming data and sending the first digital signature and the first timestamp to the first server.

In one embodiment of the invention, the method further comprises generating a second digital signature and a second timestamp associated with the second gaming data and sending the second digital signature and the second timestamp to the first server.

According to a sixth aspect of the present invention, there is provided a computer implemented method for controlling access of a user to a gaming system, the method comprising receiving from a first computer system as introduced in the third aspect, an indication indicative of an interaction of the user with the first computer system, generating an instruction based on the indication, sending the instruction to a second computer system as introduced in the first aspect, for the second computer system to control the access of the user to the gaming system based on the instruction.

In one embodiment of the invention, the indication indicates that the user does not want to use the gaming system, and the instruction causes the second computer system to disable the gaming system.

In one embodiment of the invention, the method further comprises receiving from the second computer system identity information associated with the user, usage information of the gaming system associated with use of the gaming system by the user, determining a unique identification that represents the identity information associated with the user based on the identity information and sending the unique identification and the usage information to a third computer system.

In one embodiment of the invention, the method further comprises receiving from the third computer system a further indication indicating that the user does not want to use the gaming system, generating a further instruction based on the further indication, and sending the further instruction to the second computer system for the second computer system to disable use of the gaming system by the user.

In one embodiment of the invention, the method further comprises generating a digital signature and a timestamp associated with the unique identification and the usage information and sending the digital signature and the timestamp to the third computer system.

In one embodiment of the invention, determining the unique identification comprises performing a hash operation on the identity information.

In one embodiment of the invention, determining the unique identification comprises generating a public key and a private key based on the identity information and determining the unique identification based on the public key.

According to a seventh aspect of the present invention, there is provided a computer implemented method for controlling access of a user to a gaming system, the method comprising presenting a user interaction interface on a user interaction system, the user interaction interface including a user interface element indicating that the user does not want to use the gaming system, receiving from the user interaction system an indication that the user activated the user interface element and sending the indication to a computer system as introduced in the second aspect for the computer system to disable the access of the user to the gaming system.

In one embodiment of the invention, the user interaction system comprises a touch-sensitive screen, the user interaction interface comprises a graphic user interface, and the user interface element comprises a graphic button.

In one embodiment of the invention, the method further comprises receiving, from a card reader, identity information contained in a card used by the user to access the gaming system, the identity information representing identity of the user, determining the identity of the user from the identity information, determining the user is not allowed to access the gaming system based on the identity of the user, disabling the card so as to disable the access of the user to the gaming system.

In one embodiment of the invention, the method further comprises determining a current position of the user, determining a reference position and if a difference between the current position of the user and the reference position is less than a threshold, disabling the card used by the user to disable the access of the user to the gaming system.

In one embodiment of the invention, determining the current position of the user comprising using three or more beacons to determine the current position of the user.

In one embodiment of the invention, the graphic user interface includes a further graphic user interface element indicating that the user intends to use the gaming system, and the method further comprising receiving from the touch-sensitive screen a further indication that the user activates the further graphic user interface element and sending the further indication to the computer system to enable the access of the user to the gaming system.

In one embodiment of the invention, the method further comprises disabling the user to game on the gaming system for a certain period of time.

In one embodiment of the invention, the method further comprises sending a message to a device associated with an assistance provider to alert the assistance provider, the message including the identity information representing identity of the user.

In one embodiment of the invention, the assistance provider comprises a psychologist, a caregiver, a social worker, a counsellor, a police officer or an operator of the gaming system.

According to an eighth aspect of the present invention, there is provided a computer implemented method for determining a user is not allowed to access a gaming system, the method comprising receiving from a computer system as introduced in the second aspect a unique identification associated with the user and usage information associated with of use of the gaming system by the user, determining the user is not allowed to access the gaming system based on the unique identification and the usage information and storing the usage information in association with the unique identification in a database.

In one embodiment of the invention, determining the user is not allowed to access the gaming system comprises obtaining past usage information associated with the use of the gaming system by the user from the database based on the unique identification and determining the user is not allowed to access the gaming system based on the usage information and the past usage information.

In one embodiment of the invention, the database comprises a blockchain.

In one embodiment of the invention, the method further comprises sending a computer program to a portable device associated with the user, the computer program causing the portable device to provide a current position of the user.

In one embodiment of the invention, the method further comprises receiving an indication from the portable device indicating that the user does not want to use the gaming system.

In one embodiment of the invention, the method further comprises sending the indication to the computer system to disable use of the gaming system by the user.

According to a ninth aspect of the present invention, there is provided a computer software program, including machine-readable instructions, when executed by a processor, causing the processor to perform the any one of the methods described above.

Other aspects of the invention are also disclosed.

### BRIEF DESCRIPTION OF THE DRAWINGS

Notwithstanding any other forms which may fall within the scope of the present invention, a preferred embodiment/preferred embodiments of the invention will now be described, by way of example only, with reference to the accompanying drawings in which:

FIG. 1 illustrates an exemplary environment of computing devices to which various embodiments of the present invention may be implemented;

FIG. 2 illustrates an information flow diagram for processing gaming data from two or more gaming systems, in accordance with an embodiment of the present invention;

FIG. 3 illustrates an information flow diagram for controlling access of a user to a gaming system, in accordance with an embodiment of the present invention;

FIG. 4 illustrates an information flow diagram for determination of a current position of a user using three or more beacons of a positioning device, in accordance with an embodiment of the present invention;

FIG. 5 illustrates a plurality of zones around a reference position in accordance with an embodiment of the present invention;

FIG. 6 illustrates an information flow diagram for determining a user is not allowed to access a gaming system, in accordance with an embodiment of the present invention;

FIG. 7 illustrates an exemplary blockchain in accordance with an embodiment of the present invention;

FIG. 8 illustrates an information flow diagram for obtaining the current position of the user, using a portable device associated with the user, in accordance with an embodiment of the present invention;

FIG. 9 illustrates a method for processing gaming data from two or more gaming systems, in accordance with an embodiment of the present invention;

FIG. 10 illustrates a method for controlling access of a user to a gaming system, in accordance with another embodiment of the present invention;

FIG. 11 illustrates a method for controlling access of a user to a gaming system, in accordance with an embodiment of the present invention; and

FIG. 12 illustrates a method for determining a user is not allowed to access a gaming system, in accordance with an embodiment of the present invention.

### DESCRIPTION OF EMBODIMENTS

It should be noted in the following description that like or the same reference numerals in different embodiments denote the same or similar features.

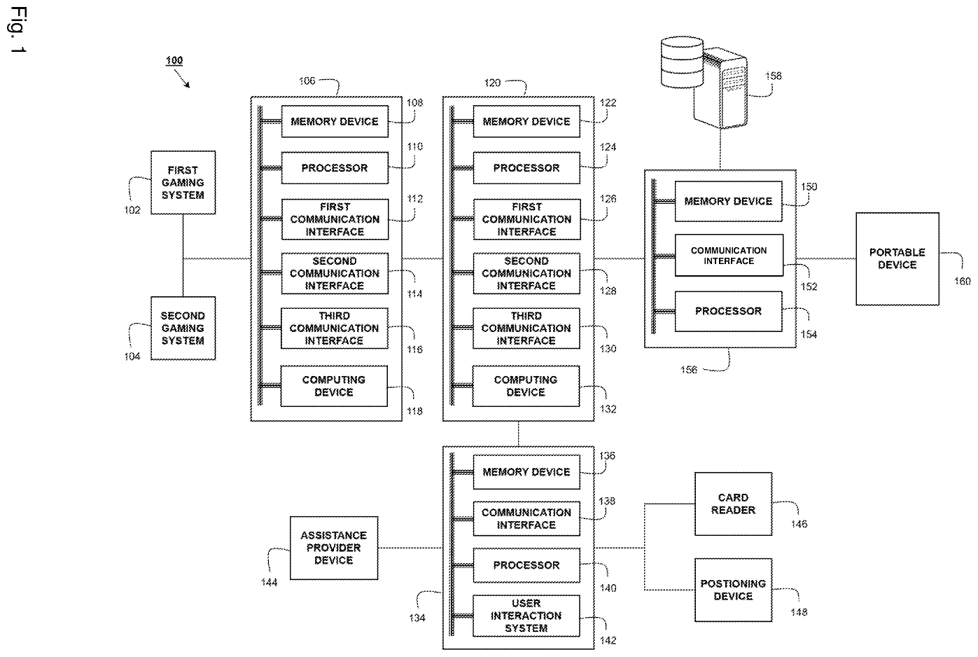

FIG. 1 illustrates an exemplary environment 100 of computing devices to which various embodiments of the present invention may be implemented. As shown in FIG. 1, the exemplary environment 100 comprises a first gaming system 102 and a second gaming system 104. For example, the first gaming system 102 is a gambling machine for placing bets on events such as horse racing, while the second gaming system 104 is a gambling machine that allows a gambler to pick up a number that may turn out to be a lucky number based on a lucky draw. The first gaming system 102 and the second gaming system 104 may operate on different protocols. Further, connected to the first gaming system 102 and the second gaming system 104 is a stub appliance 106. The stub appliance 106 comprises a number of components such as a memory device 108 configured to store machine readable instructions, a processor 110 connected to the memory device 108, a first communication interface 112 connected to the processor 110 and configured to connect to the first gaming system 102, a second communication interface 114 connected to the processor 110 and configured to connect to the second gaming system 104 and a third communication interface 116 connected to the processor 110 and configured to connect to a stub server 120.

In one embodiment of the invention, the stub appliance 106 further comprises a computing device 118. The computing device 118 is a secure communication key hardware and may be internally provided in the stub appliance 106 or may be externally connected to the stub appliance 106. In one embodiment, the stub server 120 is also responsible for communications with non-gaming elements provided by the operator of the gaming venue, such as food and beverage systems, hotel systems, and other parts of an entire ecosystem, such as electronic cash transfers.

The stub server 120 comprises a memory device 122 configured to store machine-readable instructions, a processor 124 connected to the memory device 122, a first communication interface 126 connected to the processor 124 and configured to connect to the stub appliance 106, a second communication interface 128 connected to the processor 124 and configured to connect to a kiosk unit 134.

The kiosk unit 134 comprises a memory device 136 configured to store machine-readable instructions, a processor 140 connected to the memory device 136, a communication interface 138 connected to the processor 140 and configured to connect to the stub server 120. Also, the kiosk unit 134 comprises a user interaction system 142 connected to the processor 140 to interact with the user. In one embodiment of the invention, the user interaction system 142 comprises a touch-sensitive screen, the user interaction interface comprises a graphic user interface, and the user interface element comprises a graphic button. In another embodiment, the user interaction system 142 is a speaker and microphone set for an audio-based interface.

Further connected to the kiosk unit 134 is a card reader 146 configured to read identity information from a card used by a user to access a gaming system, (such as the first gaming system 102 or the second gaming system 104), the identity information representing identity of the user. Further, connected to the kiosk unit 134 is a positioning device 148 configured to determine a current position of the user. In one embodiment of the invention, the positioning device 148 comprises three or more beacons configured to determine a current position of the user. In that manner it is envisaged that the three or more beacons are able to triangulate a position of an end user device, for example, a cellular phone being used by the user. The three or more beacons allow the user to be located relatively accurate with use of a relatively low strength network such as a Bluetooth network.

In one embodiment of the invention, the positioning device 148 includes a Global Positioning System (GPS) device. Further, connected to the kiosk unit 134 is an assistance provider device 144 associated with an assistance provider. In one embodiment, the assistance provider comprises a psychologist, a caregiver, a social worker, a counsellor, a police officer or an operator of the gaming system.

In one embodiment of the invention, the stub server 120 further comprises a third communication interface 130 configured to connect to an application server 156. In one embodiment of the invention, the application server 156 is a cloud-based application server stack. In one embodiment of the invention, the stub server 120 further comprises a computing device 132. Similar to the computing device 118, the computing device 132 is a secure communication key hardware and may be internally provided in the stub server 120 or may be externally connected to the stub server 120.

The application server 156 comprises a memory device 150 configured to store machine-readable instructions, a processor 154 connected to the memory device 150 and a communication interface 152 connected to the processor 154 and configured to connect to the stub server 120. The application server 156 is further connected to a database server 158. The database server 158 is configured to maintain one or more databases as per the requirements of the application server 156. Further, the application server 156 is connected to a portable device 160 associated with the user through a communication network, for example, a cellular network, Internet, Ethernet, Wireless Local Area Network (WLAN), or a combination thereof. In one embodiment, the portable device 130 is selected from a group including a mobile handheld device such as a cellular phone, a PDA and a tablet PC etc.

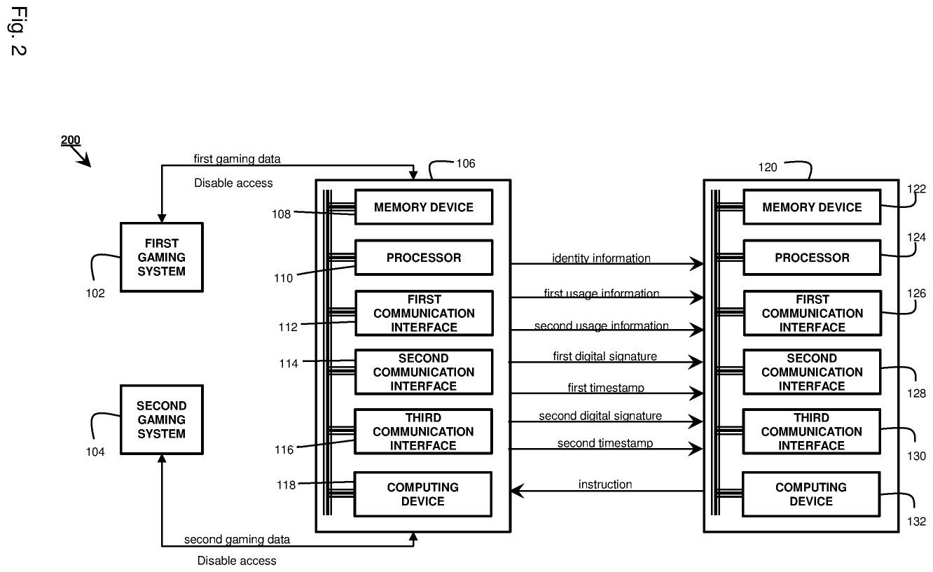

FIG. 2 illustrates an information flow diagram for processing gaming data from two or more gaming systems, in accordance with an embodiment of the present invention. The processor 110 obtains the machine-readable instructions from the memory device 108 and is configured by the machine-readable instructions to receive, via the first communication interface 112, first gaming data from the first gaming system 102, the first gaming data being generated by the first gaming system 102 based on a first protocol. Further, the processor 110 is configured to receive, via the second communication interface 114, second gaming data from the second gaming system 104, the second gaming data being generated by the second gaming system 104 based on a second protocol that is different from the first protocol. In various embodiments of the invention, the first protocol and the second protocol are selected from a group including, but not limited to, an X-Series Protocol or a Q-Comm Protocol.

Further, the processor 110 is configured to determine, from the first gaming data and based on the first protocol, identity information associated with the user and first usage information associated with use of the first gaming system 102 by the user. Further, the processor 110 is configured to determine, from the second gaming data and based on the second protocol, the identity information associated with the user and second usage information associated with use of the second gaming system 104, by the user. The identity information may include for example to a name, a membership number, an address and a contact number etc. of the user. Further, the processor 110 is configured to send the identity information, the first usage information and the second usage information to the stub server 120 via the third communication interface 116. Usage information, particularly, the first usage information and the second usage information, reflects the behaviours of the user across gaming systems that may be operated by different operators, which can be used to determine if the user is a problem gambler. This way the stub sewer 120 is able to monitor behaviours of the same user across different gaming systems.

In one embodiment of the invention, the computing device 118 is configured to generate a first digital signature and a first timestamp associated with the first gaming data and send the first digital signature and the first timestamp to the stub sewer 120. Similarly, the computing device 118 is further configured to generate a second digital signature and a second timestamp associated with the second gaming data and send the second digital signature and the second timestamp to the stub sewer 120. In one embodiment of the invention, the processor 110 is further configured to receive an instruction from the stub sewer 120 and in response to the instruction, cause the first gaming system 102 or the second gaming system 104 not to be used by the user for gaming. The instruction may be for example a ‘NOT OK TO PLAY_instruction. The generation of the instruction can be understood from the following figure.

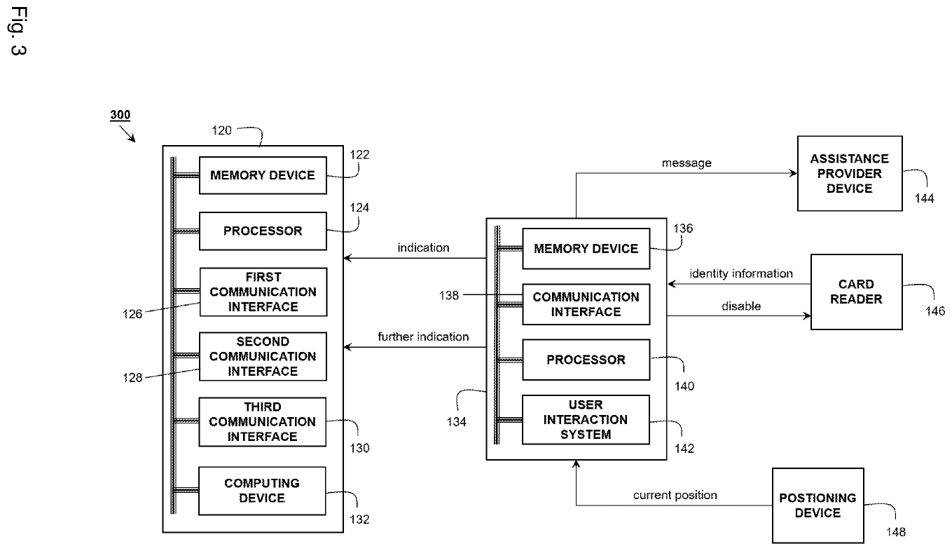

FIG. 3 illustrates an information flow diagram for controlling access of a user to a gaming system, in accordance with an embodiment of the present invention. As shown in FIG. 3, the processor 124 of the stub sewer 120 obtains the machine-readable instructions from the memory device 122 and is configured by the machine-readable instructions to receive, via the second communication interface 128, an indication indicative of an interaction of the user with the kiosk unit 134. For example, the user clicks on the ‘NOT OK TO PLAY_button (the graphic button) of the graphic user interface of the user interaction system 142 of the kiosk unit 134. Further, the processor 124 is configured to generate the instruction based on the indication. Further, the processor 124 is configured to send, via the first communication interface 126, the instruction to the stub appliance 106 for the stub appliance 106 to control the access of the user to the gaming system based on the instruction. In one embodiment of the invention, the indication indicates that the user does not want to use the gaming system, and the instruction causes the stub appliance 106 to disable the gaming system.

It should be noted that the processor 124 of the stub sewer 120 can also receive via the third communication interface 130 the indication indicating the user does not want to use the gaming system from the application server 156. The processor 124 generates the instruction based on the indication and sends, via the first communication interface 126, the instruction to the stub appliance 106 for the stub appliance 106 to disable use of the gaming system by the user. In this case, the indication may be initiated by the user activating a user interface element, for example, touching or clicking on a ‘NOT OK TO PLAY_button on the graphic user interface presented on the portable device 160 associated with the user. The indication is sent to the application server 156 through the communication network between the application server 156 and the portable device 160. The application server 156 in turn sends the indication to the processor 124 of the stub server 120 via the communication interface 152 of the application server 156.

The processor 140 of the kiosk unit 134 obtains the machine-readable instructions from the memory device 136 and is configured by the machine-readable instructions to present a user interaction interface on the user interaction system 142, for example, a graphic user interface. The user interaction interface includes a user interface element (for example, the ‘NOT OK TO PLAY_button) indicating that the user does not want to use the gaming system. Further, the processor 140 is configured to receive from the user interaction system 142 the indication that the user has activated the graphic user interface element by for example clicking on or touching the ‘NOT OK TO PLAY_button on the graphic user interface. Also, the processor 140 is configured to send, via the communication interface 138, the indication to the stub server 120 to disable the access of the user to the gaming system.

In one embodiment of the invention, the processor 140 is further configured to receive the identity information from the card reader 146 when the user inserts a loyalty card into the card reader 146. Further, the processor 140 is configured to determine the identity of the user from the identity information. Further, the processor 140 is configured to determine the user is not allowed to access the gaming system based on the identity of the user. In this manner, it is envisaged that the processor 140 is able to compare the identity of the user with for example a blacklist of problem gamblers. On confirmation that the user is a problem gambler, the processor 140 disables the card so as to disable the access of the user to the gaming system. Further, in one embodiment of the invention, the processor 140 is configured to receive the current position of the user from the positioning device 148.

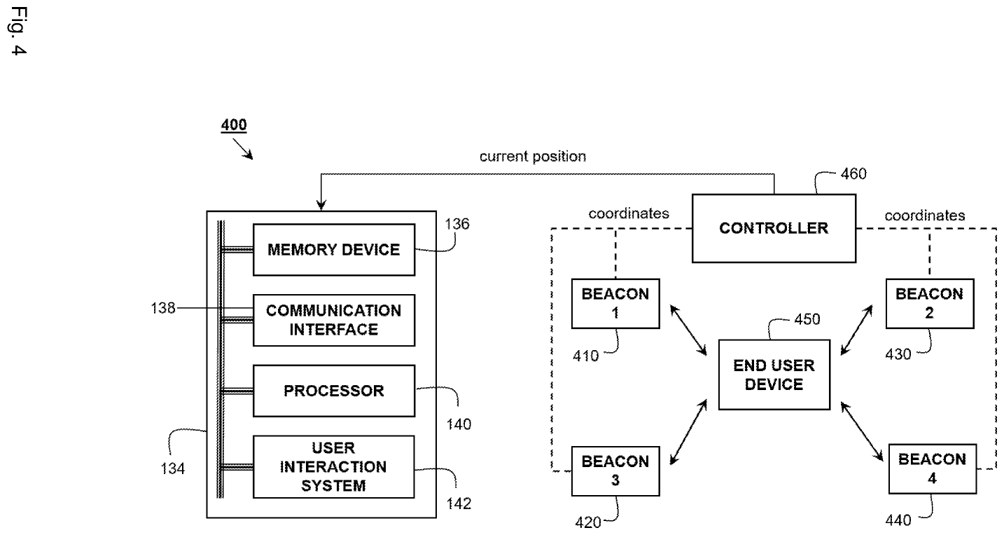

FIG. 4 illustrates an information flow diagram for determination of a current position of a user using three or more beacons of a positioning device, in accordance with an embodiment 400 of the present invention. As can be seen from the FIG. 4, four beacons 410, 420, 430 and 440 determine the current position of the user by triangulating an end user device 450. Further, coordinates of the end user device 450 are sent to a controller 460. The controller 460 determines the current position of the user, from the coordinates and transmits the current position to the processor 140 of the kiosk unit 134.

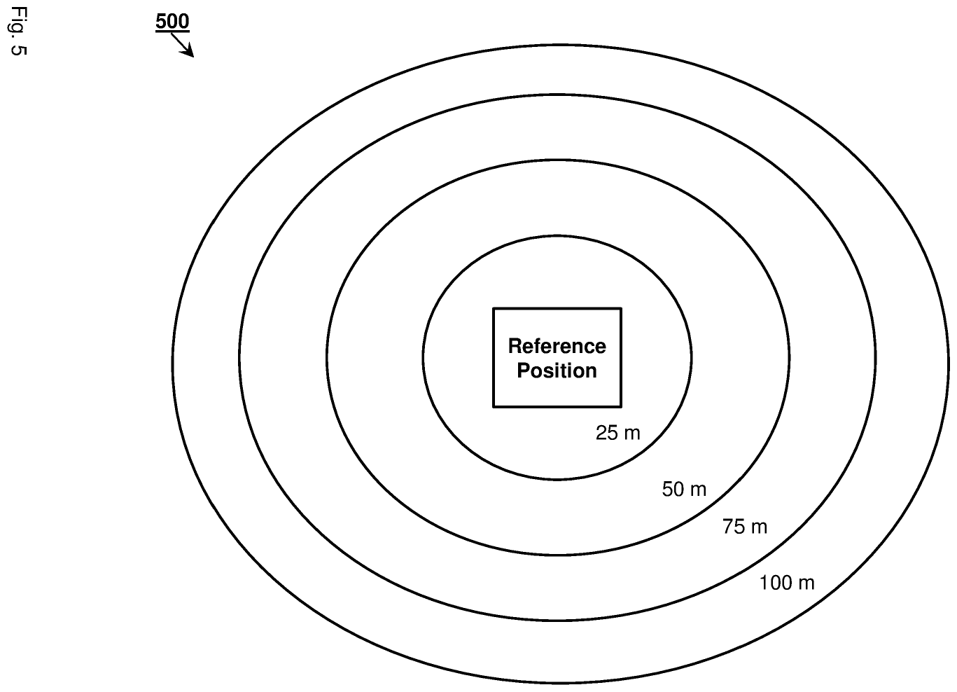

Further, the processor 140 is configured to determine a reference position, for example a position of the kiosk unit 134. Further, if a difference between the current position of the user and the reference position is less than a threshold, the processor 140 is further configured to disable the card used by the user to disable the access of the user to the gaming system. It will be appreciated by a skilled addressee that different zones may be defined based on the differences between the current position and the reference position as can be seen from FIG. 5. For example, between 75 m and 100 m is a green zone, between 50 m and 75 m is a yellow zone, between 25 m and 50 m is an orange zone and within 25 m is a red zone. Also, the disabling of the card may be initiated while the user is in any one of the zones as per the configuration of the kiosk unit 134.

In one embodiment of the invention, the processor 140 is configured to send the indication to the stub server 120 to disable the user to game on the gaming system for a certain period of time. The certain period of time may vary from a few hours to a few days or a few months depending upon a requirement as per user condition. Further, the processor 140 is configured to send a message to a device associated with the assistance provider (i.e. the assistance provider device 144, to alert the assistance provider, the message including the identity information representing identity of the user. The message may then direct the assistance provider to initiate provision of necessary assistance in terms of for example, law enforcement, counselling, re-encashment of unused chips etc.

In one embodiment of the invention, the graphic user interface includes a further graphic user interface element (for example, an ‘OK TO PLAY_button) indicating that the user intends to use the gaming system. As a consequence, the processor 140 is further configured to receive from the touch-sensitive screen a further indication that the user has activated the further graphic user interface element by for example touching the ‘OK TO PLAY_button and send, via the communication interface 138, the further indication to the stub server 120 to enable the access of the user to the gaming system.

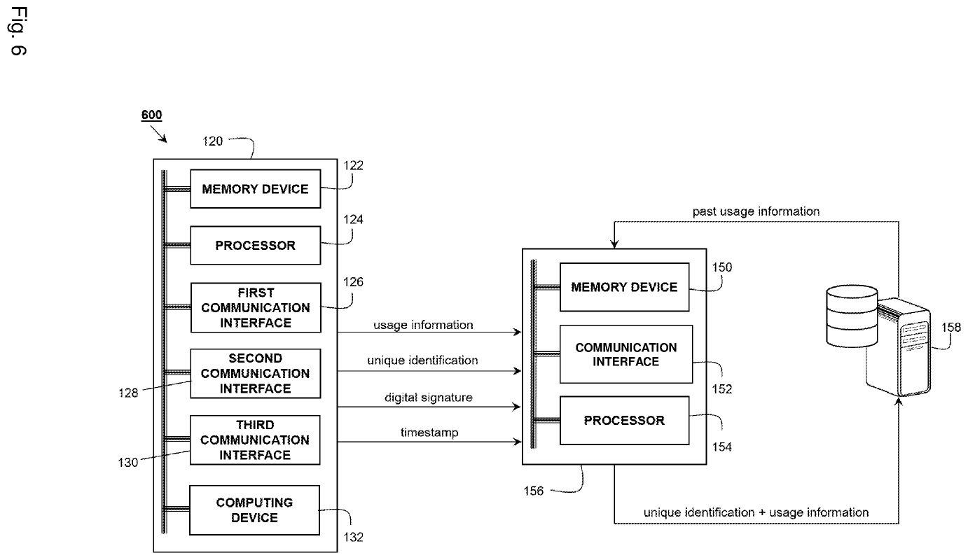

FIG. 6 illustrates an information flow diagram for determining a user is not allowed to access a gaming system, in accordance with an embodiment of the present invention. As shown in FIG. 6, the processor 124 of the stub server 120 is further configured to receive, from the stub appliance 106 via the first communication interface 126, identity information associated with the user, usage information of the gaming system 102,104 associated with use of the gaming system 102, 104 by the user. Further, the processor 124 is configured to determine a unique identification that represents the identity information associated with the user based on the identity information. The unique identification serves as a substitute for actual identity details of the user without disclosing the identity details of the user, for example, the name of the user. In this manner, the usage information and the identity information may be de-identified and hence privacy of the user is safeguarded.

In one embodiment of the invention, the processor 124 of the stub server 120 is configured to determine the unique identification by performing a hash operation on the identity information. In another embodiment, the processor 124 is configured to determine the unique identification by generating a public key and a private key based on the identity information and determining the unique identification based on the public key. Further, the processor 124 is configured to send, via the third communication interface 130, the unique identification and the usage information to the application server 156. In one embodiment of the invention, the computing device 132 is further configured to generate a digital signature and a timestamp associated with the unique identification and the usage information. Also, the computing device 132 is further configured to send the digital signature and the timestamp to the application server 156.

The processor 154 of the application server 156 obtains the machine-readable instructions from the memory device 150 and is configured by the machine-readable instructions to receive, via the communication interface 152 from the stub server 120, the unique identification associated with the user and the usage information associated with of use of the gaming system by the user. Further, the processor 154 is configured to determine the user is not allowed to access the gaming system, based on the unique identification and the usage information.

In one embodiment, the processor 154 is configured to determine the user is not allowed to access the gaming system by obtaining past usage information associated with the use of the gaming system by the user from the database maintained by the database server 158 based on the unique identification and determining the user is not allowed to access the gaming system based on the usage information and the past usage information.

For example, the usage information and past usage information include, but are not limited to, date and time of playing the gambling machines, size of bet, number of visits over a period of time and type of machine, also referred to as data points in the present specification. If it is determined from the data points that the user visits the gambling venue for example 5 times in a day, or spends for example over $1,000 in a day on a gambling machine, the user can be identified as a problem gambler and is not allowed to use the gambling machine any more.

Further, the processor 154 is configured to store the usage information received from the stub server 120 in association with the unique identification in a database maintained by the database server 158. In one embodiment of the invention, the database is a blockchain.

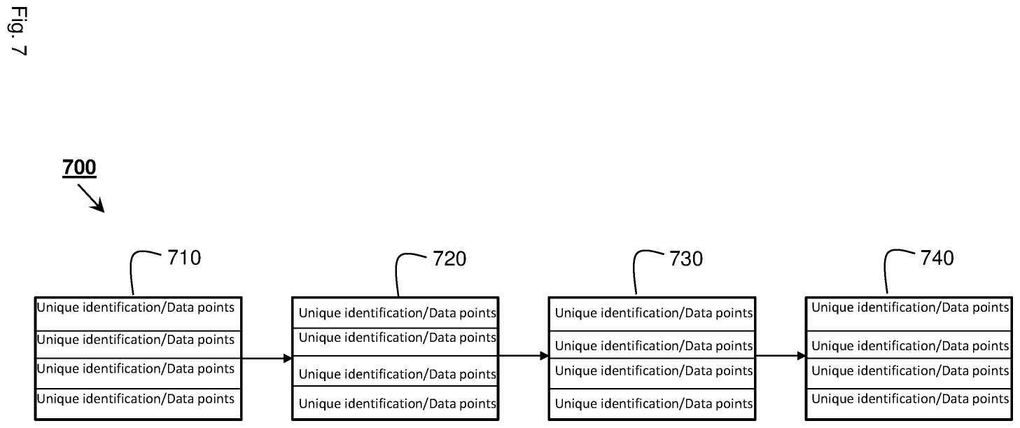

FIG. 7 illustrates an exemplary blockchain 700 in accordance with an embodiment of the present invention. The exemplary blockchain 700 comprises a plurality of blocks 710, 720, 730 and 740. Each of the blocks 710, 720, 730 and 740 includes one or more records. The blockchain 700 operates based on a consensus algorithm that adds a new block to the blockchain 700 securely, for example, the proof of work in Bitcoin. The blockchain 700 in the present disclosure contains the data points as described above and the unique identification that is able to identify the gambler without disclosing the identity of the gambler, as shown in each of the records.

In a scenario where a user indicates he or she is willing to play by touching the ‘OK TO PLAY_button on the graphic user interface of the kiosk unit 134, such an indication is transmitted from kiosk unit 134 to the stub sever 120. The stub server 120 in turn sends the induction and the unique identification of the user to the application server 156. Upon receipt of the indication and the unique identification of the user, the processor 154 of the application server 156 searches the blockchain 700 for records that contains the unique identification and extracts the data points from those records. Then the processor 154 determines if the user is a problem gambler based on the data points. If the user is not a problem gambler, the application server 156 allows the user to use the gambling machines at the gambling venue. Otherwise, the application server 156 may disable the user to use the gambling machines for a period of time, for example, 24 hours, and/or sends a message to an assistance provider to help the user deal with his or her gambling issue.

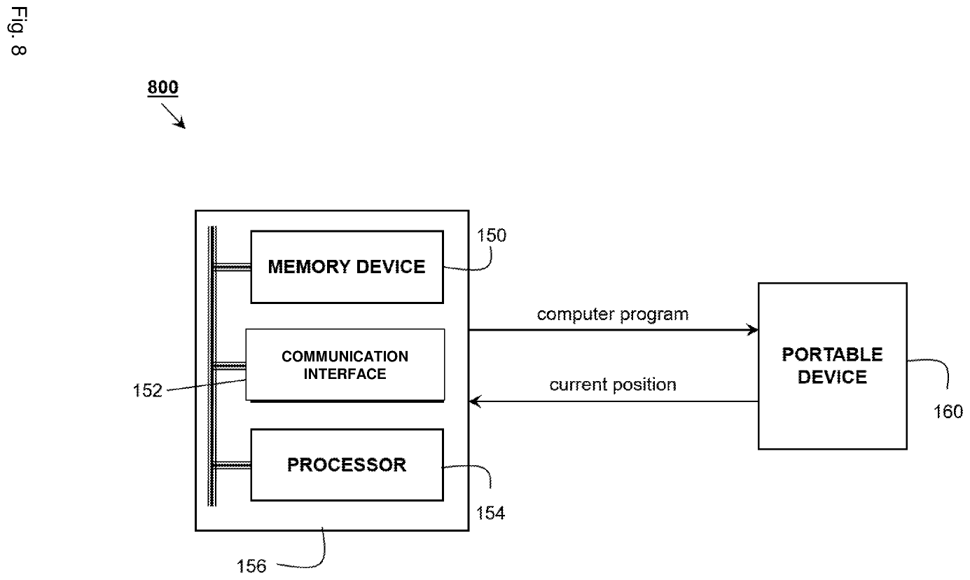

FIG. 8 illustrates an information flow diagram for obtaining the current position of the user, using the portable device 160 associated with the user, in accordance with an embodiment 800 of the present invention. As can be seen from the FIG. 8, the processor 154 of the application server 156 is further configured to send a computer program to the portable device 154 associated with the user, the computer program causing the portable device 154 to provide the current position of the user. In that manner it is envisaged that the computer program may be anyone of a, but not limited to, a snippet of code, a web plugin or a standalone application. Further, it is envisaged that the portable device 160 is equipped with a GPS device capable of determining the current position of the user. This way the processor 154 can determine the current position of the user without any need of extra hardware or devices.

In one embodiment, the computer program sent from the application sewer 156 presents a graphic user interface on the portable device 160. The graphic user interface includes a ‘NOT OK TO PLAY_button or an ‘OK TO PLAY button. If the user touches or clicks on the ‘NOT OK TO PLAY_button, an indication indicating the user does not want to use the gaming system is sent from the portable device 160 to the application sewer 156 via the communication network between the application sewer 156 and the portable device 160. The processor 154 of the application sewer 156 is configured to receive the indication from the portable device 160 indicating that the user does not want to use the gaming system. Upon receipt of the indication, the processor 154 of the application sewer 156 sends via the communication interface 152 the indication to the stub sewer 120. The processor 124 of the stub sewer 120 then generates an instruction based on the indication and sends, via the first communication interface 126, the instruction to the stub appliance 106 for the stub appliance 106 to disable use of the gaming system by the user.

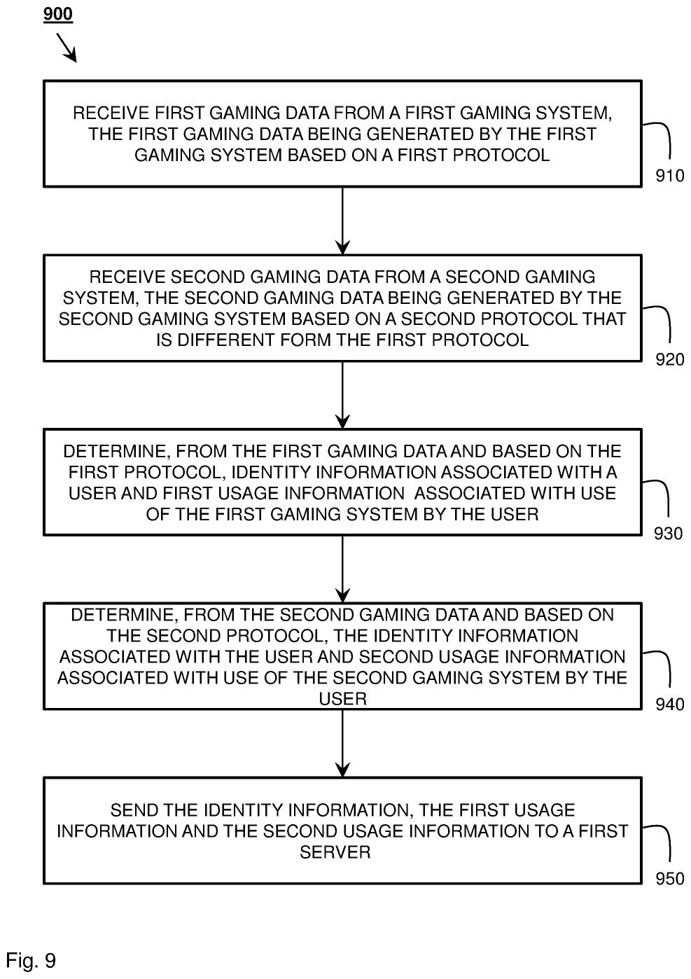

FIG. 9 illustrates a method 900 for processing the gaming data from the two or more gaming systems, in accordance with an embodiment of the present invention. The method 900 may be performed by the stub appliance 106. At step 910, the processor 110 of the stub appliance 106 receives from the first gaming system 102 the first gaming data generated by the first gaming system 102 based on a first protocol. At step 920, the processor 110 receives from the second gaming system 104 the second gaming data generated by the second gaming system based on a second protocol that is different from the first protocol. At step 930, the processor 110 determines, from the first gaming data and based on the first protocol, identity information associated with the user and first usage information associated with use of the first gaming system 102 by the user. At step 940, the processor 110 determines, from the second gaming data and based on the second protocol, the identity information associated with the user and second usage information associated with use of the second gaming system 104 by the user. At step 950, the processor 110 sends the identity information, the first usage information and the second usage information to the stub server 120.

In one embodiment of the invention, the computing device 118 of the stub appliance 106 generates the first digital signature and the first timestamp associated with the first gaming data. Further, the computing device 118 sends the first digital signature and the first timestamp to the stub server 120. Further, in one embodiment, the computing device 118 generates the second digital signature and the second timestamp associated with the second gaming data and sends the second digital signature and the second timestamp to the stub server 120. Further, in one embodiment of the invention, the processor 110 receives the instruction from the stub server 120 and in response to the instruction, causes the first gaming system 102 or the second gaming system 104 not to be used by the user for gaming.

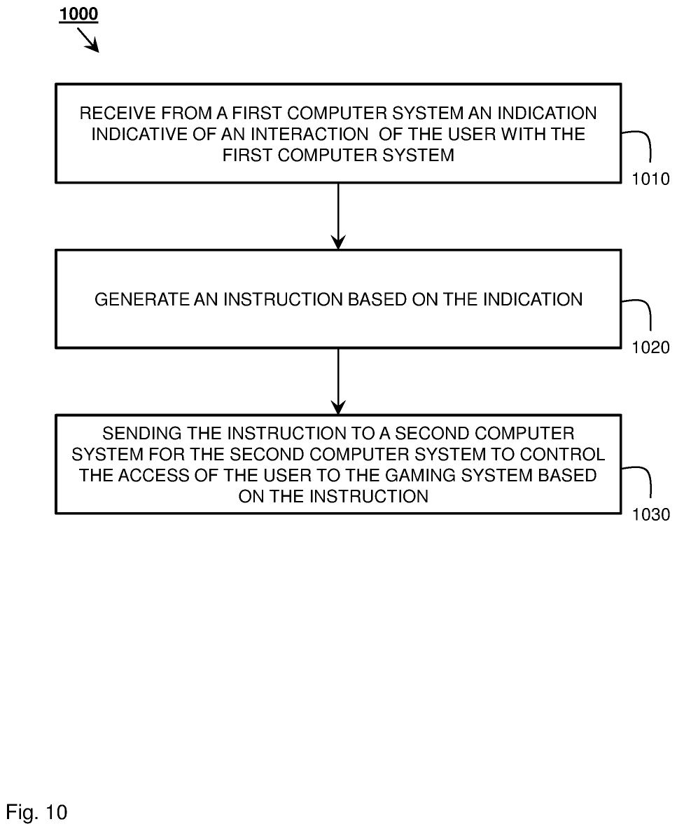

FIG. 10 illustrates a method 1000 for controlling access of a user to a gaming system, in accordance with an embodiment of the present invention. The method 1000 may be performed by the stub server 120. At step 1010, the processor 124 of the stub server 124 receives the indication indicative of the interaction of the user with the kiosk unit 134, from the kiosk unit 134. At step 1020, the processor 124 generating the instruction based on the indication. At step 1030, the processor 124 sends the instruction to the stub appliance 106 for the stub appliance 106 to control the access of the user to the gaming system based on the instruction. As described above the indication may indicate that the user does not want to use the gaming system, and the instruction causes stub appliance 106 to disable the gaming system

As described above, the processor 124 of the stub server 120 can also receive via the third communication interface 130 the indication indicating the user does not want to use the gaming system from the application server 156. The processor 124 generates the instruction based on the indication and sends, via the first communication interface 126, the instruction to the stub appliance 106 for the stub appliance 106 to disable use of the gaming system by the user.

In one embodiment, the processor 124 further receives the identity information associated with the user, the usage information of the gaming system associated with use of the gaming system by the user, from the stub appliance 106. Further, the processor 124 determines the unique identification that represents the identity information associated with the user based on the identity information. As described above, the unique identification serves as a substitute for actual identity details of the user without disclosing the identity details of the user, for example, the name of the user.

In one embodiment, determining the unique identification comprises performing the hash operation on the identity information. In another embodiment, determining the unique identification comprises generating a public key and a private key based on the identity information and determining the unique identification based on the public key. Further, the processor 124 sends the unique identification and the usage information to the application server 156. In one embodiment of the invention, the computing device 132 of the stub server 120 generates the digital signature and the timestamp associated with the unique identification and the usage information. Further, the computing device 132 sends the digital signature and the timestamp to the application server 156.

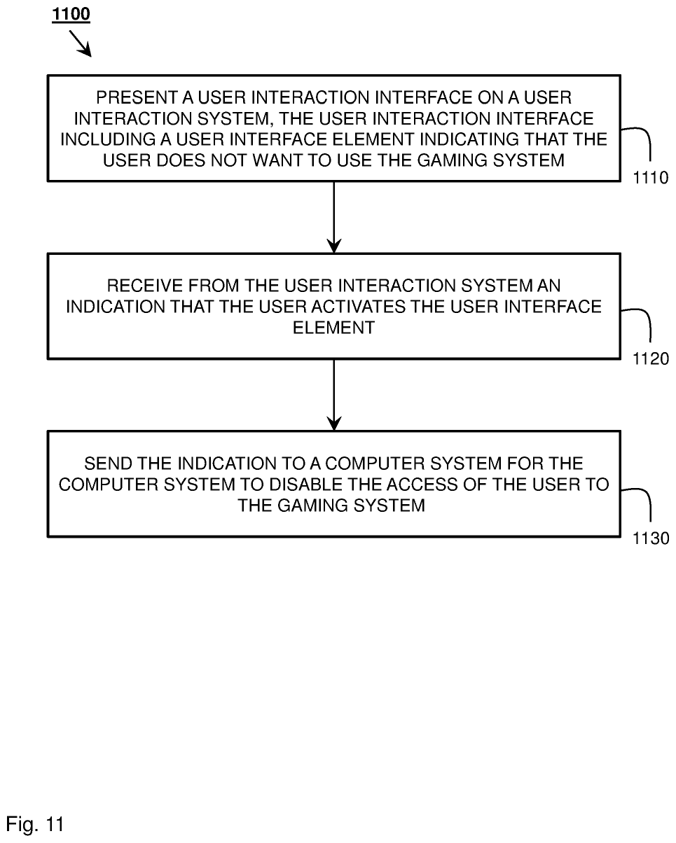

FIG. 11 illustrates a method 1100 for controlling access of the user to the gaming system, in accordance with another embodiment of the present invention. The method 1100 may be performed at the kiosk unit 134. At step 1110, the processor 140 of the kiosk unit 134 presents the user interaction interface on the user interaction system 142. The user interaction interface including a user interface element indicating that the user does not want to use the gaming system, for example, the ‘NOT OK TO PLAY_button. At step 1120, the processor 140 receives from the user interaction system 142 the indication that the user has activated the user interface element. At step 1130, the processor 140 sends the indication to the stub server 120 for the stub server 120 to disable the access of the user to the gaming system. In one embodiment, the processor 110 disables the user to game on the gaming system for the certain period of time. Further, the processor 140 sends a message to the assistance provider device 144 associated with the assistance provider to alert the assistance provider, the message including the identity information representing identity of the user.

In one embodiment of the invention, the processor 140 receives from the card reader 146 identity information contained in the card used by the user to access the gaming system, the identity information representing identity of the user. Further, the processor 140 determines the identity of the user from the identity information. Further, the processor 140 determines the user is not allowed to access the gaming system based on the identity of the user. Further, the processor 140 disables the card so as to disable the access of the user to the gaming system. In one embodiment of the invention, the positioning device 148 determines the current position of the user and transmits the current position to the kiosk unit 134. Further, the processor 140 determines the reference position, for example, a position of the kiosk unit 134. Further, if a difference between the current position of the user and the reference position is less than the threshold, the processor 140 disables the card used by the user to disable the access of the user to the gaming system. In one embodiment, determining the current position of the user comprises using the three or more beacons to determine the current position of the user.

In one embodiment of the invention, the processor 140 further receives from the touch-sensitive screen the further indication that the user has activated the further graphic user interface element by for example touching or clicking on the ‘OK TO PLAY_button. Further, the processor 140 further sends the further indication to the stub server 120 to enable the access of the user to the gaming system.

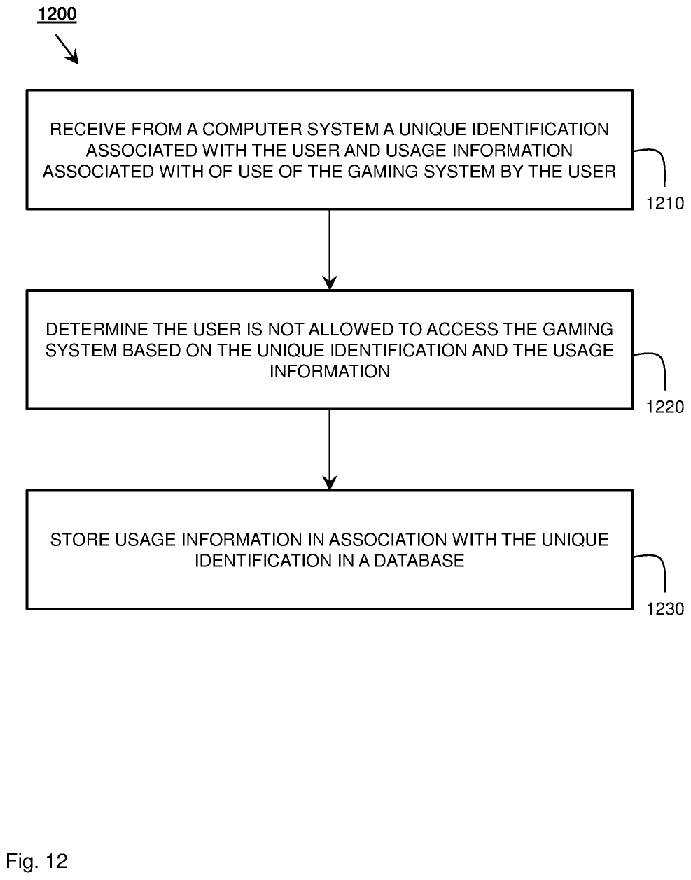

FIG. 12 illustrates a method 1200 for determining a user is not allowed to access a gaming system, in accordance with an embodiment of the present invention. The method 1200 may be performed at the application server 156. At step 1210, the processor 154 of the application server 156 receives from the stub sewer 120, the unique identification associated with the user and the usage information associated with of use of the gaming system by the user. At step 1220, the processor 154 determines the user is not allowed to access the gaming system based on the unique identification and the usage information. At step 1230, the processor 124 stores the usage information in association with the unique identification in the database maintained by the database sewer 158. In one embodiment, the processor 154 further obtains the past usage information associated with the use of the gaming system by the user from the database maintained by the database sewer 158 based on the unique identification and determines the user is not allowed to access the gaming system based on the usage information and the past usage information. In one embodiment, the processor 154 further sends a computer program to the portable device 160 associated with the user, the computer program causing the portable device 160 to provide the current position of the user.

As described above, the computer program sent from the application sewer 156 presents a graphic user interface on the portable device 160. The graphic user interface includes a ‘NOT OK TO PLAY_button or an ‘OK TO PLAY button. If the user touches or clicks on the ‘NOT OK TO PLAY_button, an indication indicating the user does not want to use the gaming system is sent from the portable device 160 to the application sewer 156 via the communication network between the application sewer 156 and the portable device 160. The processor 154 of the application sewer 156 is configured to receive the indication from the portable device 160 indicating that the user does not want to use the gaming system. Upon receipt of the indication, the processor 154 of the application sewer 156 sends via the communication interface 152 the indication to the stub sewer 120. The processor 124 of the stub sewer 120 then generates an instruction based on the indication and sends, via the first communication interface 126, the instruction to the stub appliance 106 for the stub appliance 106 to disable use of the gaming system by the user.

The steps of the above methods may be implemented as machine-readable instructions executable by the corresponding processors. The machine-readable instructions may be divided into one or more computer programs, such as dynamic link libraries (DLL), wherein each of the libraries performs one or more steps of the methods.

The embodiments of the system and method described above offer a number of advantages. The systems and methods allow collection of gaming data from different gaming systems that traditionally do not communicate with each other. This enables the identification of problem gamblers based on the gaming data across different gaming systems. Also, the invention provides the user with the option to identify himself or herself as a problem gambler by using the ‘NOT OK TO PLAY_button, which allows harm minimization in the gaming industry. Further, de-identification of the user related data ensures that the privacy of the user is not compromised. Additionally, the invention allows research on usage information associated with use of gaming systems by users with a view to identifying problems gamblers. The invention is also able to provide the problem gamblers with assistance through an assistance provider. Further, the de-identified data generated can be used for performing research on behavioural patterns of problem gamblers and identifying potential problem areas on a larger scale.

Throughout this specification, unless the context requires otherwise, the words ‘comprise_, ‘comprises_ and ‘comprising_ will be understood to imply the inclusion of a stated step or element or group of steps or elements but not the exclusion of any other step or element or group of steps or elements.

Any one of the terms: ‘including_ or ‘which includes_ or ‘that includes_ as used herein is also an open term that also means including at least the elements/features that follow the term, but not excluding others.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

### INDUSTRIAL APPLICABILITY

It is apparent from the above, that the arrangements described are applicable for gaming, betting, gambling, harm minimization and associated research-based industries.

1. A computer system for processing gaming data from two or more gaming systems, the computer system comprising:
a memory device configured to store machine-readable instructions;
a processor connected to the memory device; and
a first communication interface connected to the processor and configured to connect to a first gaming system; and
a second communication interface connected to the processor and configured to connect to a second gaming system that is different from the first gaming system;
a third communication interface connected to the processor and configured to connect to a first server;
wherein the processor obtains the machine-readable instructions from the memory device and is configured by the machine-readable instructions to:
receive, via the first communication interface, first gaming data from the first gaming system, the first gaming data being generated by the first gaming system based on a first protocol;
receive, via the second communication interface, second gaming data from the second gaming system, the second gaming data being generated by the second gaming system based on a second protocol that is different from the first protocol;
determine, from the first gaming data and based on the first protocol, identity information associated with a user and first usage information associated with use of the first gaming system by the user;
determine, from the second gaming data and based on the second protocol, the identity information associated with the user and second usage information associated with use of the second gaming system by the user; and
send the identity information, the first usage information and the second usage information to the first server via the third communication interface.

2. The computer system as claimed in claim 1, wherein the processor is further configured to
receive an instruction from the first server; and
in response to the instruction, cause the first gaming system or the second gaming system not to be used by the user for gaming.

3. The computer system as claimed in claim 1, further comprising a computing device configured to:
generate a first digital signature and a first timestamp associated with the first gaming data; and
send the first digital signature and the first timestamp to the first server.

4. The computer system as claimed in claim 3, wherein the computing device is further configured to
generate a second digital signature and a second timestamp associated with the second gaming data; and
send the second digital signature and the second timestamp to the first server.

5. A computer system for controlling access of a user to a gaming system, the computer system comprising:
a memory device configured to store machine-readable instructions;
a processor connected to the memory device;
a first communication interface connected to the processor and configured to connect to a first further computer system as claimed in claim 1, the first further computer system being connected to the gaming system;
a second communication interface connected to the processor and configured to connect to a second further computer system, the second further computer system being configured to interact with the user;
wherein the processor obtains the machine-readable instructions from the memory device and is configured by the machine-readable instructions to:
receive, via the second communication interface, an indication indicative of an interaction of the user with the second further computer system;
generate an instruction based on the indication;
send, via the first communication interface, the instruction to the first further computer system for the first further computer system to control the access of the user to the gaming system based on the instruction.

6. The computer system as claimed in claim 5, wherein the indication indicates that the user does not want to use the gaming system, and the instruction causes the first further computer system to disable the gaming system.

7. The computer system as claimed in claim 5, the computer system further comprising a third communication interface configured to connect to a third further computer system.

8. The computer system as claimed in claim 7, wherein the processor is further configured to
receive, from the first further computer system via the first communication interface, identity information associated with the user, usage information of the gaming system associated with use of the gaming system by the user;
determine a unique identification that represents the identity information associated with the user based on the identity information; and
send, via the third communication interface, the unique identification and the usage information to the third further computer system.

9. The computer system as claimed in claim 7, wherein the processor is further configured to
receive via the third communication interface from the third further computer system a further indication indicating that the user does not want to use the gaming system;
generate a further instruction based on the further indication;
send, via the first communication interface, the further instruction to the first further computer system for the first further computer system to disable use of the gaming system by the user.

10. The computer system as claimed in claim 7, further comprising a computing device configured to
generate a digital signature and a timestamp associated with the unique identification and the usage information; and
send the digital signature and the timestamp to the third further computer system.

11. The computer system as claimed in claim 5, wherein the processor is configured to determine the unique identification by performing a hash operation on the identity information.

12. The computer system as claimed in claim 5, wherein the processor is configured to determine the unique identification by
generating a public key and a private key based on the identity information; and
determining the unique identification based on the public key.

13. A computer system for controlling access of a user to a gaming system, the computer system comprises:
a memory device configured to store machine-readable instructions;
a processor connected to the memory device;
a communication interface connected to the processor and configured to connect to a further computer system as claimed in claim 5; and
a user interaction system connected to the processor to interact with the user;
wherein the processor obtains the machine-readable instructions from the memory device and is configured by the machine-readable instructions to:
present a user interaction interface on the user interaction system, the user interaction interface including a user interface element indicating that the user does not want to use the gaming system,
receive from the user interaction system an indication that the user activates the graphic user interface element; and
send, via the communication interface, the indication to the further computer system to disable the access of the user to the gaming system.

14. The computer system as claimed in claim 13, wherein the user interaction system comprises a touch-sensitive screen, the user interaction interface comprises a graphic user interface, and the user interface element comprises a graphic button, wherein the graphic user interface includes a further graphic user interface element indicating that the user intends to use the gaming system, and the processor is further configured to receive from the touch-sensitive screen a further indication that the user activates the further graphic user interface element; and send, via the communication interface, the further indication to the further computer system to enable the access of the user to the gaming system.

15. The computer system as claimed in claim 13, further comprising:
a card reader configured to read identity information from a card used by the user to access the gaming system, the identity information representing identity of the user and a positioning device configured to determine a current position of the user,
wherein the processor is further configured to
receive the identity information from the card reader;
determine the identity of the user from the identity information;
determine the user is not allowed to access the gaming system based on the identity of the user;
disable the card so as to disable the access of the user to the gaming system;
receive the current position of the user from the positioning device;
determine a reference position; and
if a difference between the current position of the user and the reference position is less than a threshold, disable the card used by the user to disable the access of the user to the gaming system.

16-19. (canceled)

20. The computer system device as claimed in claim 13, wherein the processor is configured to send the indication to the further computer system to disable the user to game on the gaming system for a certain period of time.

21. The computer system as claimed in claim 15, the processor is further configured to send a message to a device associated with an assistance provider to alert the assistance provider, the message including the identity information representing identity of the user.

22. (canceled)

23. A computer system for determining a user is not allowed to access a gaming system, comprising:
a memory device configured to store machine-readable instructions;
a processor connected to the memory device;
a communication interface connected to the processor and configured to connect to a further computer system as claimed in claim 5; and
wherein the processor obtains the machine-readable instructions from the memory device and is configured by the machine-readable instructions to:
receive, via the communication interface from the further computer system, an unique identification associated with the user and usage information associated with of use of the gaming system by the user;
determine the user is not allowed to access the gaming system based on the unique identification and the usage information; and
store usage information in association with the unique identification in a database.

24. The computer system as claimed in claim 23, wherein the processor is configured to determine the user is not allowed to access the gaming system by
obtaining past usage information associated with the use of the gaming system by the user from the database based on the unique identification; and
determining the user is not allowed to access the gaming system based on the usage information and the past usage information.

25. (canceled)

26. The computer system as claimed in claim 23, wherein the processor is further configured to:
send a computer program to a portable device associated with the user, the computer program causing the portable device to provide a current position of the user;
receive an indication from the portable device indicating that the user does not want to use the gaming system; and
send, via the communication interface, the indication to the further computer system to disable use of the gaming system by the user.

27-55. (canceled)
